(19) United States
(12) Patent Application Publication
(10) Pub. No.: US 2024/0252862 A1
(43) Pub. Date: Aug. 1, 2024

(54) Housing for an Electrical Energy Store

(71) Applicant: Ford Global Technologies, LLC, Dearborn, MI (US)

(72) Inventors: Chris James Leck, Enfield (GB); Anita Raghunath Chaudhari, South Woodham Ferrers (GB)

(21) Appl. No.: 18/102,329

(22) Filed: Jan. 27, 2023

(51) Int. Cl. A62C 3/16; A62C 37/40; H01M 50/383

(52) U.S. Cl. CPC A62C 3/16; A62C 37/40; H01M 50/383

(57) ABSTRACT

A housing for an electrical energy store is an enclosure used to contain and protect an electrical energy store, such as a vehicle battery. The housing may provide the necessary protection and support for the electrical energy store and may be shaped appropriately to accommodate the electrical energy store and openings for fire extinguishing medium to flow through. The housing may also include mounting arrangements so it may be mounted within or onto a vehicle. The housing may have a first opening for providing a fire extinguishing medium to the housing and a second opening to allow the fire extinguishing medium to be collected from the housing. At least one of the first opening and the second opening may comprise a closure arranged to prevent access to the fluid flow path of at least one of the first and second openings until at least one pre-defined condition is met.

### BACKGROUND

The present disclosure relates to devices and methods for fire prevention, containment or extinguishing of an electrical energy store inside a vehicle. More particularly, but not exclusively, the present disclosure relates to the provision of a fluid flow path for a fire-extinguishing medium to reach a battery pack through a first opening and exit through a second opening.

### SUMMARY

Electrical energy stores such as lithium-ion and lithium polymer batteries, and other battery types found inside electric and hybrid electric vehicles may, when overheated, short circuited or otherwise compromised, suffer from malfunction.

Most batteries found within electric, or hybrid electric vehicles are located beneath the vehicle body and are heavily encased, making access to the battery difficult for firefighters and rescue personnel in case of emergency.

Electric vehicle battery fires can require many thousands of gallons of water exposure before they are fully extinguished, many times more than that of conventional vehicle fires. Due to the nature of chemical reactions inside the battery cell, an electric vehicle battery fire may reignite hours or days after being extinguished.

As the percentage of electric vehicles on the road increases, the large quantities of water required to extinguish such fires becomes increasingly difficult to sustain, especially in areas already affected by water scarcity or areas where a constant water source is difficult to obtain.

There is also a likelihood of potentially environmentally unfriendly waste material from the combusted battery escaping into the environment while being flushed with extinguishant.

According to some aspects of the disclosure, devices and methods are provided that comprise a housing for an electrical energy store, the housing comprising a first and second opening each arranged to allow access to an interior of the housing, wherein the first opening is attachable to an arrangement configured to provide means for providing a fire extinguishing medium to the housing, and the second opening is arranged to allow the fire extinguishing medium to be collected from the housing, and the first opening is arranged to provide a fluid flow path for the fire extinguishing medium to pass over an electrical energy store positioned inside the housing and the second opening is arranged to provide a fluid flow path for the fire extinguishing medium to exit the housing, and wherein at least one of the first opening and the second opening comprises a closing means arrangement configured arranged to prevent access to the fluid flow path of at least one of the first and second openings until at least one pre-defined condition is met.

In some examples, at least one of the first opening and the second opening further comprises a conduit, the conduit being arranged to provide a fluid flow path between the exterior of the body of a vehicle and the interior of the housing.

In some examples, the conduit is arranged to provide access between the exterior of the body of a vehicle and the interior of the housing through a manifold.

In some examples, the fire extinguishing medium is recirculated from the second opening back into the first opening through a recirculation arrangement.

In some examples, the recirculation arrangement is different from the arrangement configured to provide a fire extinguishing medium.

In some examples, the housing for an electrical energy store further comprises a flange arranged to provide a channel for guiding the fire extinguishing medium between the interior of the housing and the exterior of the housing.

In some examples, the first opening is attachable to the arrangement configured to provide the fire extinguishing medium to the housing through a quick-fit connection.

In some examples, the closing arrangement is biased into a closed position.

In some examples, the closing arrangement is a solenoid, the solenoid being powered shut.

In some examples, the housing for an electrical energy store further comprises a temperature sensor arranged detect the temperature of the electrical energy store.

In some examples, at least one pre-defined condition is met when the electrical energy store exceeds a temperature of 100 degrees Celsius.

According to one aspect of the disclosure, a method is provided for providing a fire extinguishing medium to a housing for an electrical energy store having an opening and a closing arrangement arranged over the opening, the method comprising detecting, using a temperature sensor, a temperature within the housing for an electrical energy store, determining, using control circuitry, if the temperature within the housing for the electrical energy store exceeds a predefined threshold and, in response to the temperature of the electrical energy store exceeds a pre-defined threshold, moving the closing arrangement from a closed position to an open position, such that the opening in the housing may receive an arrangement for providing a fire extinguishing medium to the housing.

In some examples, the temperature sensor is configured to detect the temperature of an electrical energy store inside the housing for an electrical energy store.

In some examples, a temperature sensor reading is taken at pre-determined intervals.

According to one aspect of the disclosure, a vehicle is provided which comprising the housing for an electrical energy store as previously described, and wherein the vehicle body further comprises an opening corresponding to each of the first and second openings of the housing.

In some examples, at least one of the first opening and the second opening of the housing further comprises at least one conduit, the or each conduit being arranged to provide a fluid flow path between the exterior of the body of a vehicle and the interior of the housing.

In some examples, the or each conduit is arranged to provide access between the exterior of the body of a vehicle and the interior of the housing through a manifold.

In some examples, the vehicle further includes flaps arranged to cover openings on the exterior of the body of the vehicle.

In some examples, the vehicle further includes a temperature sensing arrangement connected to control circuitry, wherein the temperature sensing arrangement is configured to detect a temperature of the interior of the housing.

In some examples, the flaps open when at least one pre-defined condition is met, and preferably wherein the pre-defined condition is a temperature of the interior of the housing.

It shall be appreciated that other features, aspects and variations of the present disclosure will be apparent from the disclosure of the drawings and detailed description. Additionally, it will be further appreciated that additional or alternative examples of methods of and systems for controlling an electrical accessory may be implemented within the principles set out by the present disclosure.

### FIGURES

The above and other objects and advantages of the disclosure will be apparent upon consideration of the following detailed description, taken in conjunction with the accompanying drawings, in which:

FIG. 1 shows a simplified diagram of a housing for an electrical energy store, in accordance with some examples of the disclosure.

FIG. 2 shows a simplified diagram of an alternative housing for an electrical energy store inside a vehicle, in accordance with some examples of the disclosure.

FIG. 3 shows a simplified diagram of another alternative housing for an electrical energy store inside a vehicle, in accordance with some examples of the disclosure.

FIG. 4 shows a simplified diagram of a further alternative housing for an electrical energy store inside a vehicle, in accordance with some examples of the disclosure.

FIG. 5 shows a simplified diagram of another alternative housing for an electrical energy store inside a vehicle, in accordance with some examples of the disclosure.

FIG. 6 shows an exemplary view of a quick fit connector, in accordance with some examples of the disclosure.

FIG. 7 shows an exemplary diagram of a vehicle comprising an electrical energy store, in accordance with some examples of the disclosure.

FIG. 8 shows an exemplary diagram of a vehicle comprising an electrical energy store, in accordance with some examples of the disclosure.

FIG. 9 shows an exemplary diagram of a vehicle comprising an electrical energy store, in accordance with some examples of the disclosure.

FIG. 10 shows an exemplary diagram of a vehicle comprising an electrical energy store, in accordance with some examples of the disclosure.

FIG. 11 shows a flowchart representing a method for providing a fire extinguishing medium to a housing for an electrical energy store, in accordance with some examples of the disclosure.

The figures herein depict various examples of the disclosed disclosure for purposes of illustration only. It shall be appreciated that additional or alternative structures, systems and methods may be implemented within the principles set out by the present disclosure.

### DETAILED DESCRIPTION

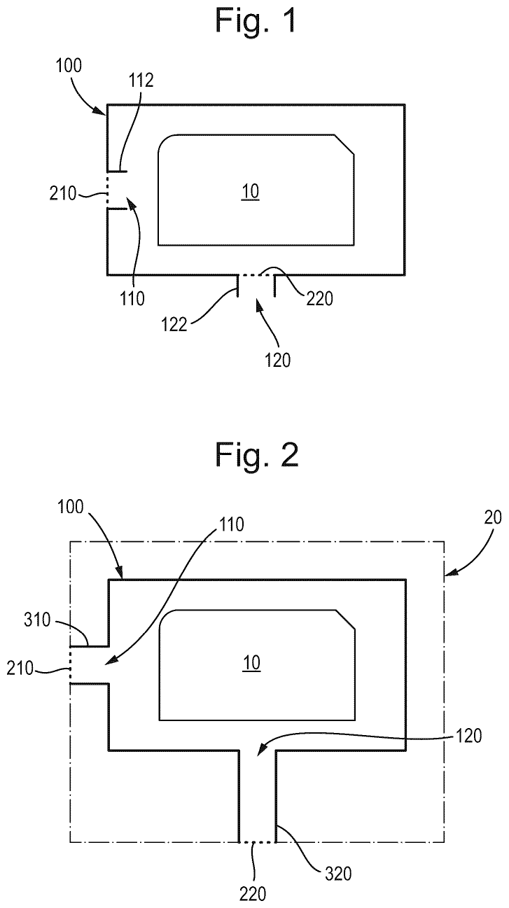

FIG. 1 shows a simplified diagram of a housing 100 for an electrical energy store 10, in accordance with some examples of the disclosure. The housing for the electrical energy store comprises a first opening 110 and a second opening 120.

The openings 110, 120 are arranged to allow access to an interior of the housing 100. The first opening 110 is attachable to a means or arrangement for providing a fire extinguishing medium to the housing 100, and the second opening 120 is arranged to allow the fire extinguishing medium to be collected from the housing 100.

The first opening 110 is arranged to provide a fluid flow path for the fire extinguishing medium to pass over an electrical energy store 10 positioned inside the housing 100 and the second opening 120 is arranged to provide a fluid flow path for the fire extinguishing medium to exit the housing 100.

At least one of the first opening 110 and the second opening 120 comprises a closing means or arrangement 210 and 220, arranged to prevent access to the fluid flow path of at least one of the first and second openings 110, 120 until at least one pre-defined condition is met.

The first and second openings 110, 120 may be positioned in any way relative to the housing 100 so long as they are able to fulfil their stated function. The specific positioning will depend on the design and function of the housing 100 and the electrical energy store 10 it contains.

In some examples the first opening 110 could be located on the top of the housing 100, while the second opening 120 could be located on the bottom of the housing 100. This would allow the fire extinguishing medium to flow down over the electrical energy store inside the housing 100 and out through the second opening 120.

In some examples the first and second openings 110, 120 could both be located on the same side of the housing 100, but at different heights. This would allow the fire extinguishing medium to flow horizontally across the electrical energy store 10 inside the housing 100 and out through the second opening 120.

In some examples the first opening 110 could be located on one end of the housing 100, while the second opening 120 could be located on the opposite end. This would allow the fire extinguishing medium to flow through the housing 100 in a linear fashion, passing over the electrical energy store 10 as it goes.

In some examples the first and second openings 110, 120 could be located on opposite sides of the housing 100, with the electrical energy store 10 positioned vertically inside the housing 100. This would allow the fire extinguishing medium to flow vertically over the electrical energy store 10 and out through the second opening 120.

The housing 100 for the electrical energy store 10 may have any shape as long as it is able to contain and protect the electrical energy store 10 and provide the necessary openings for the fire extinguishing medium to flow through.

The openings 110, 120 may also have any shape as long as they are able to fulfil their stated functions. Ultimately, the shape of the openings 110, 120 will depend on the design of the housing 100 and the specific needs of the system. As long as the openings 110, 120 are able to allow the fire extinguishing medium to flow over the electrical energy store 10 inside the housing 100 and out through the second opening 120, they may be any shape.

In some examples the openings 110, 120 could be circular, allowing the fire extinguishing medium to flow smoothly through the housing 100.

In some examples, the openings 110, 120 could be rectangular or square, which may be more practical for certain types of housing 100 designs for which an attached device is prevented from turning rotationally while attached.

In some examples, the openings 110, 120 could be elongated and narrow, allowing the fire extinguishing medium to flow through the housing 100 in a more focused manner.

In some examples, the openings 110, 120 could be irregularly shaped, such as a hexagon or a triangle, depending on the specific design requirements of the housing 100.

The housing 100 for the electrical energy store may be made of any material that is able to provide the necessary protection and support for the electrical energy store 10 and the fire extinguishing system.

The housing 100 for the electrical energy store 10 may include mounting arrangements to allow it to be mounted within or onto a vehicle. Some examples of different types of mounting arrangements that could be used include brackets, screws, clamps, adhesives or any type of mounting arrangement that is strong and secure enough to withstand the vibrations and movements of the vehicle during operation.

In some examples extending members 112 and 122 may be added to the openings of the housing 100 in order to direct the flow of the fire extinguishing medium or to provide a more stable and secure attachment point for devices that may be attached to the openings 110, 120.

For example, extending members 112, 122 which protrude out from the opening 110, 120 could be used to guide the flow of the fire extinguishing medium over the electrical energy store 10 inside the housing. The extending members 112, 122 could be shaped and positioned in such a way as to direct the flow of the fire extinguishing medium in a specific direction or to cover specific areas of the electrical energy store 10.

In some examples, extending members 112, 122 that protrude in from the opening 110, 120 could be used as a guide for devices that may be attached to the openings 112, 122. For example, a hose or other attachment device could be fitted over the extending member 112, 122, allowing it to be securely connected to the opening 110, 120. The extending member 112, 122 may provide a guide for the attachment device, helping to align it with the opening 112, 122 and providing a stable and secure connection.

Overall, the use of extending members 112, 122 on the openings of a housing 100 for an electrical energy store 10 can be advantageous in helping to guide the flow of the fire extinguishing medium or in providing a secure and stable attachment point for devices that may be attached to the openings 110, 120.

FIG. 2 shows the simplified diagram of a housing 100 for an electrical energy store 10 of FIG. 1, further comprising a conduit 310 or 320, arranged to provide a fluid flow path between the exterior of the body of a vehicle 20 and the interior of the housing 100.

In some examples, the conduit 310, 320 is cylindrical, or any other shape suitable for providing a fluid flow path for solid, liquid, or gaseous fire extinguishing mediums. The conduit 310, 320 may take any shape, so long as it can enclose the medium, as may be suitable in this regard. In some examples there are multiple conduits 310, 320 arranged to provide a fluid flow path between the exterior of the body of a vehicle 20 and each of the first and second openings 210, 220.

In some examples, the conduit 310, 320 is metal or a composite with a metal sheath or any other material suitable for withstanding the high temperatures of an electrical energy store 10 that is undergoing thermal runaway and subsequent combustion. This temperature may be more than 100 degrees Celsius and may be as high as 1000 degrees Celsius. The conduit 310, 320 may also be subjected to low temperatures around or below 0 degrees Celsius. This may be the temperature of any suitable fire extinguishing medium such as CO₂, which may be expelled from a fire extinguisher at or around −60 degrees Celsius. Within the context of this disclosure, the conduit 310, 320 may be made of any material tough enough to withstand such conditions for a duration long enough to provide a suitable amount of fire extinguishing medium to the housing 100 to render the electrical energy store 10 stable and to prevent, mitigate or extinguish any potential fire.

The exterior of the body of a vehicle 20 and the housing 100 wall, in some circumstances, either unintentionally or by design, may be arranged such that they are able to move relative to each other. In some examples, the conduit 310, 320 may be flexible to accommodate any movement between the exterior of the body of a vehicle 20 and the housing 100 wall. In some examples the conduit 310, 320 is made flexible by its construction, e.g., flexible metal conduit with corrugated outer walls or, by its inherent material property, e.g., a temperature-resistant flexible plastic or both, e.g., a flexible plastic inner core sheathed with an interlinked metallic outer structure.

In some examples, the conduit 310, 320 is configured to provide a fluid flow path in only one direction and comprises flow management devices such as one-way valves. In some examples the conduit 310, 320 may be arranged to increase or decrease flow rate in one direction and comprises flow management devices such as restrictors or nozzles. The conduit 310, 320 may be configured such that the velocity and volumetric flow rate of the fire extinguishing medium entering or exiting the conduit 310, 320 is controlled such that the housing 100 may be completely filled by the medium and the electrical energy store 10 is fully enclosed by the medium before the medium is allowed to exit the housing 100.

In some examples, the conduit 310, 320 is attached to the exterior of the body of a vehicle 20 and the housing 100 wall. The conduit 310, 320 may be attached to a surface by any suitable means including but not limited to screws, bolts, rivets, flange, weld, thread, and compression fit.

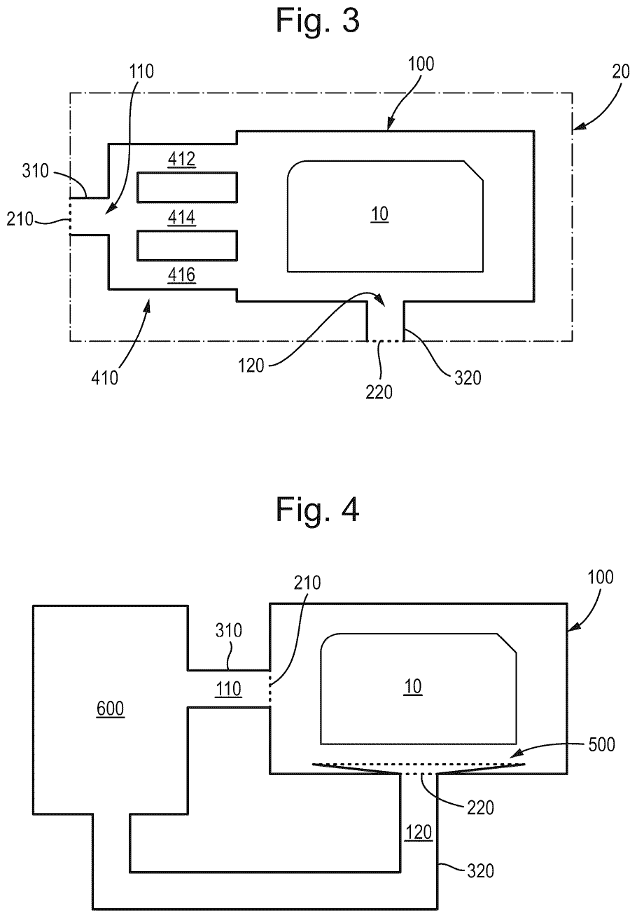

FIG. 3 shows the simplified diagram of a housing 100 for an electrical energy store 10 of FIG. 2 wherein the conduit is a manifold 410.

A manifold 410 within the context of this disclosure may mean a conduit 310, 320, or a plurality thereof, accommodating multiple flow paths 412, 414 and 416. The manifold 410 may further comprise multiple inlets and outlets for the provision of fluid flow paths 412, 414, 416 between the exterior of the body of a vehicle 20 and the interior of the housing 100.

A manifold 410 comprising multiple flow paths 412, 414, 416 can be advantageous for several reasons. A blockage, or obstruction to a single flow path will not completely block access to the exterior of the body of a vehicle 20 or the interior of the housing 100. Also, in case of blockage, alternate flow paths may also accommodate for pressure within the interior of the housing 100 to equalize, thus, allowing the fire extinguishing medium to exit the housing 100 at a consistent rate. Multiple flow paths 412, 414, 416 may also be beneficial in providing multiple inlets and outlets to increase the rate that the fire extinguishing medium can be delivered to or exit from the housing 100.

The manifold 410 may be arranged in a plurality of ways, e.g., comprising at least two or more flow paths 412, 414, 416, comprising multiple flow paths 412, 414, 416 between a single inlet 110 and outlet 120, comprising multiple flow paths 412, 414, 416 between multiple inlets 110 and a single outlet 120, and/or comprising multiple flow paths 412, 414, 416 between a single inlet 110 and multiple outlets 120.

In some examples the manifold 410 could be designed with multiple inlets 110, allowing it to be connected to multiple sources of the fire extinguishing medium. This could be useful in situations where the primary source of the fire extinguishing medium is not sufficient to extinguish the fire, or if there is a need to switch to a secondary source of the fire extinguishing medium.

In some examples the manifold 410 could be designed with multiple outlets 120, allowing it to distribute the fire extinguishing medium to multiple locations within the housing 100. This could be useful in situations where the fire extinguishing medium needs to be directed to specific areas within the housing 100 in order to extinguish the fire.

In some examples the manifold 410 could include a valve or other mechanism to adjust the flow rate of the fire extinguishing medium. This could be useful in situations where it is necessary to control the amount of fire extinguishing medium that is released in order to effectively extinguish the fire or to address a thermal runaway or other thermal event.

In some examples the manifold 410 could be designed to automatically release the fire extinguishing medium in response to certain pre-defined conditions, such as the detection of a fire or the activation of a manual release mechanism. This could be useful in situations where it is not practical for a person to manually activate the fire extinguishing system.

FIG. 4 shows a simplified diagram of a housing 100 for an electrical energy store 10 wherein the fire extinguishing medium is recirculated from the second opening back into the first opening through a recirculation arrangement 600. In the context of this disclosure, a recirculation arrangement 600 could be used to recirculate the fire extinguishing medium during it being used to, or after it has been used to extinguish a fire or to control a thermal event.

The recirculation arrangement 600 may comprise a pump and a filter to circulate the fire extinguishing medium through the housing 100 and remove any contaminants or debris. The filtered fire extinguishing medium could then be stored in a tank or other container for future use.

The recirculation arrangement 600 may comprise a heat exchanger to transfer heat from the fire extinguishing medium to a secondary fluid, such as water or air. The cooled fire extinguishing medium could then be stored in a tank or other container for future use.

The recirculation arrangement 600 could use evaporation and condensation to recycle the fire extinguishing medium. In this case, the fire extinguishing medium may be evaporated and then condensed back into a liquid form, which could then be stored in a tank or other container for future use.

The recirculation arrangement 600 may comprise a chemical treatment system to remove any contaminants or impurities from the fire extinguishing medium. The treated fire extinguishing medium may be stored in a tank or other container for future use.

The recirculation arrangement 600 may be any device capable of redirecting the flow of fire extinguishing medium from an opening of the housing 100, back into the housing 100. Such devices may include emergency response vehicles. In some examples, the recirculation arrangement 600 is the same as the means or arrangement for providing a fire extinguishing medium.

In some examples the housing 100 further comprises a guiding member 500, arranged in the housing 100 or the conduit 310, 310 of a system for extinguishing a fire in a housing 100 for an electrical energy store 10 can be used to provide a channel for guiding the fire extinguishing medium between the interior of the housing and the exterior of the housing 100.

In some examples the guiding member 500 is in the form of a flange or baffle. In the context of a system for extinguishing a fire in a housing 100 for an electrical energy store 10, a flange could be used to provide a channel for guiding the fire extinguishing medium between the interior of the housing and the exterior of the housing 100.

For example, the guiding member 500 may be a flange positioned at the opening of the housing 100 or at the end of a conduit 310, 320 that connects the housing 100 to the exterior of the vehicle 20. The flange could be shaped and positioned in such a way as to guide the flow of the fire extinguishing medium between the interior and exterior of the housing 100.

In some examples, the guiding member 500 may be a baffle used to provide a channel for guiding the fire extinguishing medium between the interior and exterior of the housing 100. A baffle is a device that is used to deflect, divert, or obstruct the flow of a fluid or gas. In the context of a system for extinguishing a fire in a housing 100 for an electrical energy store 10, a baffle could be used to guide the flow of the fire extinguishing medium between the interior and exterior of the housing 100.

The use of a guiding member 500 in the form of a flange or baffle arranged in the housing 100, or the conduit 310, 320 may be advantageous in providing a channel for guiding the fire extinguishing medium between the interior and exterior of the housing 100. This may help to ensure that the fire extinguishing medium is delivered to the appropriate location and that it is able to effectively extinguish the fire.

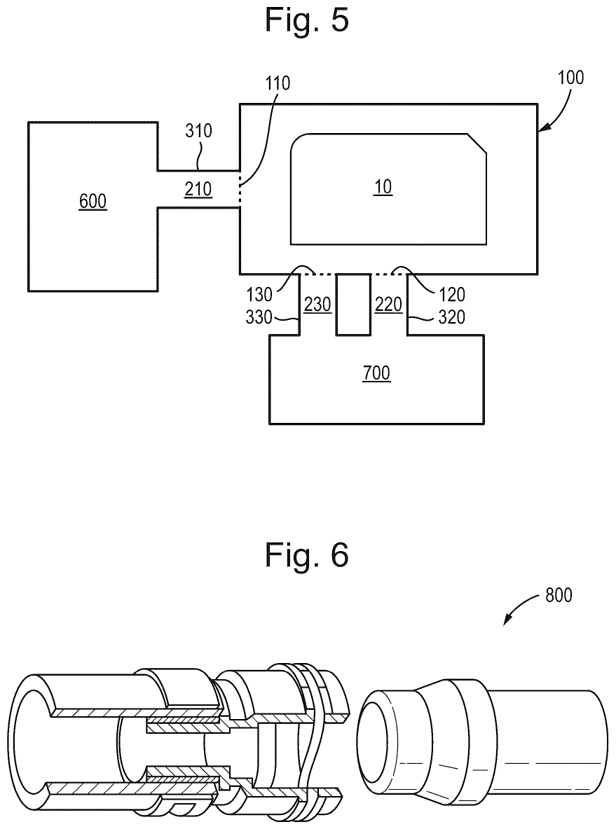

FIG. 5 Shows an arrangement whereby the recirculation means or arrangement 700 and the means or arrangement for providing a fire extinguishing medium 600 are two separate components in a system for extinguishing a fire in a housing 100 for an electrical energy store 10. While they are both related to the fire extinguishing system, they may serve different functions and may have different designs and features.

The recirculation means 700 may comprise an additional opening 130, conduit 330 and closing means 230 to allow for the fire extinguishing medium to circulate between the two or more openings of the recirculation means 700.

Within the context of such an arrangement the primary purpose of the recirculation means 700 is to recycle or reuse the fire extinguishing medium, while the primary purpose of the means for providing a fire extinguishing medium 600 is to supply the fire extinguishing medium to the housing 100. As previously stated, the recirculation means 700 may also serve the purpose of filtering out foreign material from the used fire extinguishing medium and may also remove heat accumulated from the used fire extinguishing medium.

In some examples the recirculation arrangement 700 may include components such as pumps, filters, heat exchangers, or chemical treatment systems, while the means for providing a fire extinguishing medium 600 may include components such as tanks, hoses, or nozzles.

In some examples the means for providing a fire extinguishing medium 600 may be attachable externally, while the recirculation means 700 may be integrated internally to the housing 100 for the electrical energy store 10. Both components act separately and as such, may take the form of an externally attachable device, an internally integrated device or any combination thereof.

Within the context of this disclosure, the recirculation arrangement 700 is typically connected to the second opening 120 of the housing 100, while the means for providing a fire extinguishing medium 600 is typically connected to the first opening 110 of the housing 100. However, both the first opening and second opening 110, 120 are interchangeable in their function and purpose.

In some examples the recirculation arrangement 700 is activated at the same time as the means for providing a fire extinguishing medium 600, allowing the fire extinguishing medium to be recirculated and conditioned by the recirculation arrangement 700 while the housing 100 for the electrical energy store 10 is being filled.

In some examples the recirculation arrangement 700 is activated after the means for providing a fire extinguishing medium 600, allowing the housing 100 for the electrical energy store 10 to be filled with the fire extinguishing medium before the recirculation arrangement 700 is activated and the means for providing the fire extinguishing medium 600 is deactivated.

FIG. 6 shows a quick-fit connection 800 arranged to provide a means for attaching a fire extinguishing medium to the housing 100. The quick-fit connection 800 may be connected directly to, or positioned at or near, an opening 110, 120 of the housing 100. The quick-fit connection 800 may also be arranged on one end of a conduit 310, 320 which is attached to an opening of the housing 100. In some examples the quick-fit connection 800 itself may be a conduit 310, 320 configured to provide a fluid flow path for the fire extinguishing medium to enter the housing 100.

In some examples, the quick-fit connector 800 may be positioned in a location that is easily accessible, such as on the front of the vehicle, near or under the hood, on either side of the vehicle or on the rear, or near to or in the trunk of the vehicle. In some cases, the quick-fit connector 800 may be positioned at or near the roof of the vehicle, and may be positioned on or in the A, B, or C pillar of the vehicle. In some cases the quick-fit connector 800 may be at or near the sill or the floor or underside of the vehicle.

Such positioning of the quick-fit connector 800 may allow emergency services to quickly and easily connect the means for providing a fire extinguishing medium to the housing 100 in the event of an incident involving the electrical energy store 10. In general, the quick fit connector 800 may be positioned anywhere on the vehicle such that it is able to make connection with the means for providing a fire extinguishing medium 600 to the housing 100 and the electrical energy store 10.

Quick-fit connections 800 are connections that can be easily and quickly attached or detached from a device or tool. Some examples of quick-fit connections include: Snap-on connectors, which use a spring-loaded mechanism to securely attach the attachment to the device or tool through a pushing movement, quick-release connectors, which use a lever or button to quickly release the attachment from the device or tool, bayonet connectors, which use a twisting motion to attach the attachment to the device or tool, clamp connectors, which use a screw or lever to tighten the attachment onto the device or tool and magnetic connectors, which use a magnet to attach the attachment to the device or tool.

In the context of a housing 100 for an electrical energy store 10, a quick fit connection 800 could be used to quickly and easily attach the first opening 110 of the housing 100 to a means for providing a fire extinguishing medium 600, such as a fire suppression system or a water source. The quick fit connector 800 may allow a connection to me made at a distance which does not require a person to manually operate the connector up close, potentially exposing the person to a situation which may be less than optimal.

In a situation where a vehicle battery is on fire, a quick fit connection 800 can be advantageous because it allows the fire extinguishing medium to be quickly and easily deployed to extinguish the fire. This can help to reduce the likelihood of ill effect to people or property and minimize any ill effect to the vehicle.

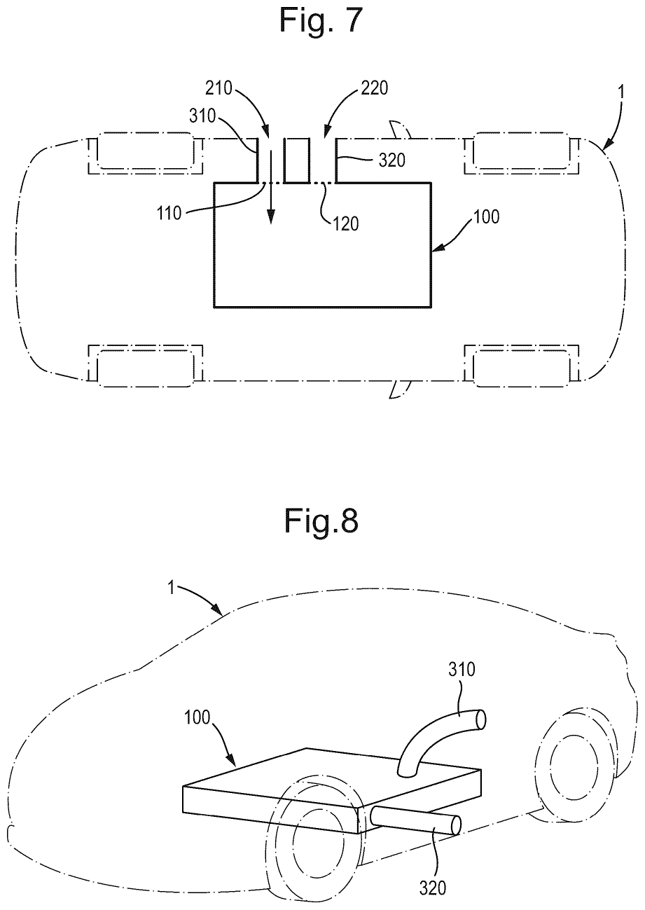

FIG. 7 shows the underside of a vehicle 1, and a view of a housing 100 for an electrical energy store comprising a closing means 210 and 220, arranged to prevent attachment to at least one of the first and second openings 110 and 120, until at least one pre-defined condition is met. The closing means 210, 220 may be any suitable means that prevents attachment to an opening 110, 120 of the housing 100 and subsequently cuts off the fluid flow path between the means for providing a fire extinguishing medium and the interior of the housing 100.

In some examples, the closing means 210, 220 is biased into a closed position. In other words, the closing means 210, 220 will remain closed until an action is taken to open it. This is useful in examples where the closing means 210, 220 is electrically powered shut and if a supplied power is lost or is deactivated, the closing means 210, 220 will not automatically open. This can be achieved in several ways, e.g., through a mechanical seal which remains closed until a pre-defined condition is met, such as a perishable seal which is configured to degrade or perish at a specified temperature or an electronically powered valve which is configured to receive a control signal from a control circuitry is a specified temperature is detected. In some examples, the closing means 210, 220 is a solenoid which moves from a closed position to an open position when an electrical current is received. In some examples the closing means 210, 220 is any suitable means which is biased into a closed position and opens only when a pre-defined condition is met.

In some examples, the closing means 210, 220 may be a flap or cover which, otherwise biased into an open position, is held in a closed position by a solenoid or similar, with the solenoid holding the flap or cover into a closed position with the application of an electrical current. On removal or deactivation of the electrical current, the solenoid or similar may release and allow the flap or cover to move into an open position.

In some examples the closing means 210, 220 is a valve that is used to control the flow of a fluid. They are designed to open or close a passageway in a pipe or other system in order to allow or prevent the flow of the fluid. The valve may be activated manually using a handle or lever, or it may be activated automatically using a control circuitry. There are several different types of valves that could be used in a housing for a vehicle battery, including gate valves, ball valves, and butterfly valves.

In some examples the closing means 210, 220 is a damper that is used to control the flow of air or other gases. Dampers are typically used to manage the flow of air in heating, ventilation, and air conditioning systems. Dampers may also be activated manually using a handle or lever, or they may be activated automatically using a control circuitry. There are several different types of dampers that could be used in a housing for a vehicle battery, including butterfly dampers, louvre dampers, and motorized dampers.

In some examples the closing means 210, 220 is a flap or hinged panel that is used to control the flow of a fluid. There are several different types of flaps that could be used in a housing for a vehicle battery, including disc flaps, plate flaps, and wing flaps.

In the context of a housing 100 for an electrical energy store 10, a flap could be located internally, within the structure of the housing 100, or within a conduit or device attached to the housing 100. The flap may also be located externally, e.g., on the surface of a vehicle 1 or external device, so long as the flap fulfills the function of effectively preventing the fire extinguishing medium from flowing through the openings 110, 120 until a predefined condition is met.

FIG. 8 shows the outline of a vehicle comprising a housing 100 for an electrical energy store further comprising conduits 310 and 320, arranged to provide a fluid flow path between the exterior of the body 20 of a vehicle 1 and the interior of the housing 100.

To provide this fluid flow path, the conduits 310 and 320, may be attached to both the exterior of the vehicle 1 and the housing 100. This could be done using fittings or other connectors, depending on the specific design of the system.

The housing 100 for an electrical energy store 10 may be positioned in any type of vehicle 1, including passenger vehicles. In some examples, the housing 100 may be positioned at the base of the vehicle 1, where it may be difficult to reach.

In the event of an incident involving the electrical energy store 10, such as a battery thermal runaway event or a fire, it may be necessary for emergency services to access the housing 100 in order to properly deal with the incident. However, the position of the housing 100 at the base of the vehicle 1 may make it difficult for emergency services to reach and access the housing 100.

To address this issue, the vehicle 1 may need to be modified to allow emergency services to properly deal with an incident involving the electrical energy store 10. For example, the vehicle 1 may be equipped with flaps or other access points that can be opened to allow emergency services to access the housing 100.

Regardless of the specific location of the housing 100 in the vehicle 1, it is important that the vehicle 1 is designed and equipped with features that allow emergency services to effectively deal with an incident involving the electrical energy store 10. This could include features previously discussed such as quick-fit connections, recirculation arrangements, and other components that are designed to help extinguish a fire and mitigate the ill effect caused by the incident.

In some examples the conduits 310, 320 are not permanently attached to either the exterior of the vehicle 1 or the housing 100 or both. The conduits 310, 320 may pass through an opening on the exterior of the vehicle 1 or the housing 100 and be free to otherwise move in and out of the opening.

Once one or both of the conduits 310, 320 are suitably located, the fire extinguishing medium may flow from the exterior of the vehicle 1 through the or each conduit 310, 320 and into the interior of the housing 100. The fire extinguishing medium would then be able to flow over the electrical energy store 10 inside the housing 100 and out, in some cases, through the second opening 120.

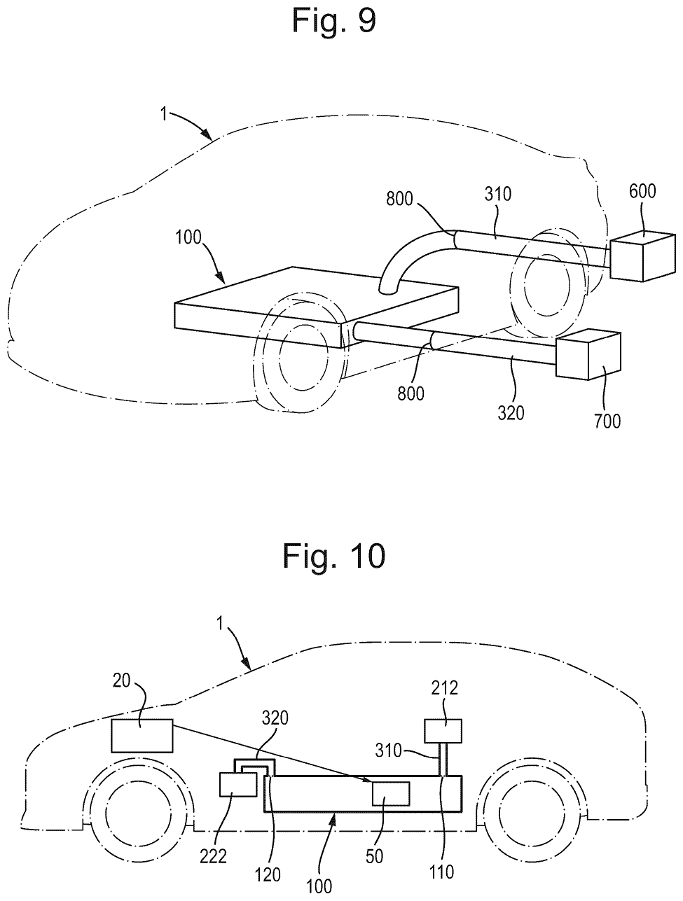

FIG. 9 shows the outline of a vehicle comprising a housing 100 for an electrical energy store whereby the recirculation means 700 and the means for providing a fire extinguishing medium 600 are two separate components in a system for extinguishing a fire in a housing 100 for an electrical energy store 10.

The conduits 310 and 320, may be integrated into the overall design of the system. The specific manner in which the conduits 310, 320 are integrated will depend on the specific design of the system and the requirements of the application.

In some examples, the conduits 310, 320 may be integrated into the housing 100 for the electrical energy store 10. For example, the conduits 310, 320 may be incorporated into the walls of the housing 100, forming a fluid flow path between the interior of the housing 100 and the exterior of the vehicle 1. The conduits 310, 320 may be positioned at the first and second openings 110, 120 of the housing 100, allowing the fire extinguishing medium to flow over the electrical energy store 10 inside the housing 100 and out through the second opening 120.

In some examples, the conduits 310, 320 may be integrated into the exterior of the vehicle 1, forming a fluid flow path between the exterior of the vehicle 1 and the interior of the housing 100. The conduits 310, 320 may be connected to the first and second openings 110, 120 of the housing 100, allowing the fire extinguishing medium to be provided into the housing 100 and collected from the housing 100 as needed.

The housing for the electrical energy store 100, may be located in the vehicle 1, and may contain the electrical energy store 10, such as a vehicle battery. The housing 100, as previously stated, may comprise a first opening 110, that is attachable to a means for providing a fire extinguishing medium 600 and a second opening 120, that is arranged to allow the fire extinguishing medium to be collected from the housing 100 by way of a recirculation means 700.

The means for providing a fire extinguishing medium 600 may be a separate component from the recirculation means 700. The means for providing a fire extinguishing medium 600 could be a fire suppression system, a water source, or any other device that is capable of providing a fire extinguishing medium to the housing 100. The means for providing a fire extinguishing medium 600 may be connected to the first opening 110 of the housing 100 using a quick fit connection 800 as described above, or other suitable connection method.

The recirculation means 700 may be a separate component from the means for providing a fire extinguishing medium 600. The recirculation means 700 may be responsible for recycling or reusing the fire extinguishing medium after it has been used to extinguish the fire in the housing 100. The recirculation means 700 could include components such as pumps, filters, heat exchangers, or chemical treatment systems. The recirculation means 700 could be connected to the second opening 120 of the housing 100 using a suitable connection method.

In the event of a fire in the housing 100 or a thermal runaway event, or at least one predefined condition being met, the closing means could be activated into an open position and the means for providing a fire extinguishing medium 600 could supply the fire extinguishing medium to the housing 100. The fire extinguishing medium 600 could flow through the first opening 110 and over the electrical energy store 10 inside the housing 100, extinguishing the fire. The fire extinguishing medium could then be collected through the second opening 120 and passed through the recirculation means 700 for recycling or reuse.

This type of system may allow for an efficient and effective means of extinguishing a fire in the housing 100 for an electrical energy store 10 in a vehicle 1, while also conserving resources by recycling or reusing the fire extinguishing medium.

FIG. 10 shows the outline of a vehicle comprising a housing for an electrical energy store further comprising flaps 212 and 222 arranged to cover openings on the exterior of the body of the vehicle, control circuitry 20 and a sensing apparatus 50.

A control circuitry 20, with a sensing apparatus 50, such as a temperature sensor 50, can be used to detect the temperature within a housing 100 for an electrical energy store 10, and open flaps 212 and 222, on the surface of a vehicle 1 arranged to allow access to the openings 110, 120 of the housing 100.

In some examples the temperature sensor 50 may be located within the housing 100 and could be used to measure the temperature within the housing 100 or the temperature of the electrical energy store 10. The sensor 50 may be in communication with the control circuitry 20 either through wired or wireless means, which could be responsible for monitoring the temperature readings from the sensor 50 and determining when the temperature within the housing 100 has reached or exceeded a pre-defined threshold.

If the control circuitry determines 20 that the temperature within the housing 100 has reached the threshold, it could activate the flaps 212, 222 on the surface of the vehicle 1. The flaps 212, 222 could be arranged to cover the openings 110, 120 of the housing 100 and may be connected to the control circuitry 20 and controlled thereby using a suitable activation mechanism, such as a motor, solenoid or other actuator.

When the flaps 212, 222 are activated, they may open to reveal the openings 110, 120 of the housing 100. This would allow access to the openings 110, 120, allowing the fire extinguishing medium to flow into the housing 100 and extinguish the fire.

In some examples, once the fire has been extinguished and the temperature within the housing has returned to an appropriate level, the control circuitry 20 may deactivate the flaps 212, 222 and close them, this sealing off the openings 110, 120 of the housing 100.

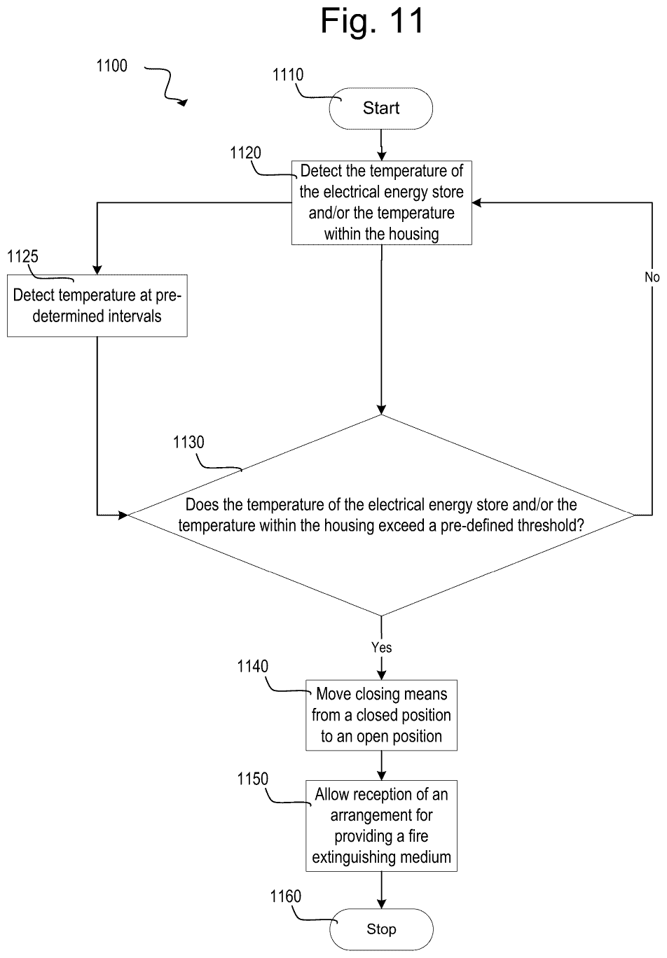

FIG. 11 shows a flow chart of a method 1100 for providing a fire extinguishing medium to a housing for an electrical energy store. The method may be used with the housings 100 for an electrical energy store 10 as described herein, or with any suitable housing 100 for an electrical energy store 10.

The method may comprise providing a housing 100 for an electrical energy store 10 which comprises a first and second opening 110, 112 each arranged to allow access to an interior of the housing 100, wherein at least one of the first opening 110 and the second opening 112 comprises a closing means arranged to prevent access to the fluid flow path of at least one of the first and second openings until at least one pre-defined condition is met. The method further includes the step of providing a sensing apparatus 50 which may be a temperature sensor 50. The method may also include the step of providing a fire extinguishing medium to a housing 100 for an electrical energy store 10.

The process may commence at step 1110, and may then proceed to step 1120. At step 1120, the method may detect the temperature of the electrical energy store 10, with such a detection being carried out by way of sensing apparatus 50. On detection of the temperature of the electrical energy store 10, the process may then proceed to step 1130. At step 1130, a determination may be made as to whether the temperature of the electrical energy store 10 exceeds a pre-defined threshold.

If the temperature of the electrical energy store 10 does not exceed a pre-defined threshold, the process may return to step 1120, with the temperature of the electrical energy store 10 detected again, before the process continues again to step 1130. The detection step 1120 may occur periodically, continuously, at an interval determined by the current state of the electrical energy store 10, or by any suitable means.

At step 1125, the process may detect the temperature at predetermined intervals in a similar way to that described in connection with step 1120.

If the temperature of the electrical energy store 10 does exceed a pre-defined threshold, the process may then advance to step 1140, in which the closing means may move from a closed position to an open position. At step 1150, the first opening 110 may then receive a means for providing a fire extinguishing medium as described herein, such that the fire extinguishing medium may pass over the electrical energy store 10 positioned inside the housing 100 and the fire extinguishing medium may exit from the second opening 112 as described herein. The process may then stop at step 1160.

The method for providing a fire extinguishing medium to a housing 100 for an electrical energy store 10 described in FIG. 11 may involve the use of a housing 100 that has a first opening 110 and a second opening 112, each arranged to allow access to the interior of the housing 100. At least one of these openings 110, 112, such as the first opening 110, is equipped with a closing means that is arranged to prevent access to the fluid flow path of the opening 110, 112 until at least one pre-defined condition is met.

The pre-defined condition that triggers the opening of the closing means could be a variety of things, depending on the specific design of the system. For example, the pre-defined condition could be the detection of a fire within the housing 100, the activation of a manual control system, or the presence of a particular chemical or gas.

Once the pre-defined condition is met, the closing means changes from a closed position to an open position. This allows the first opening 110 to receive a means for providing a fire extinguishing medium to the housing 100. The means for providing a fire extinguishing medium could be a fire suppression system, a water source, or any other device that is capable of providing a fire extinguishing medium to the housing 100.

The fire extinguishing medium could then flow through the first opening 110 and over the electrical energy store 10 positioned inside the housing 100. The fire extinguishing medium would pass through the housing, extinguishing the fire as it goes. The fire extinguishing medium may then exit the housing 100 through the second opening 112.

In some examples the closing means of a housing 100 for an electrical energy store 10 may open before a potential fire starts or if a fire is predicted to start if the control circuitry is programmed to do so. This could be done through the use of a predictive fire suppression system or other advanced control system.

A predictive fire suppression system may be equipped with sensors and algorithms that are able to detect and analyze patterns and trends in the data collected from the sensors. The system could use this data to make predictions about the likelihood of a fire occurring in the future.

If the predictive fire suppression system determines that there is a high probability of a fire occurring in the near future, it may activate the closing means to open before the fire starts. This could allow the fire extinguishing medium to be provided to the housing 100 in advance of the fire, increasing the chances of the fire being extinguished before it has a chance to spread.

In some examples, the control circuitry may be programmed to open the closing means if certain pre-defined conditions are met, even if a fire has not yet started. For example, the control circuitry may be programmed to open the closing means if the temperature within the housing reaches a certain threshold or if a particular chemical or gas is detected within the housing.

This disclosure is made for the purpose of illustrating the general principles of the systems and processes discussed above and are intended to be illustrative rather than limiting. More generally, the above description is meant to be exemplary and not limiting and the scope of the disclosure is best determined by reference to the appended claims. In other words, only the claims that follow are meant to set bounds as to what the present disclosure includes.

While the present disclosure is described with reference to particular example applications, it will be appreciated that the disclosure is not limited hereto and that particular combinations of the various features described and defined in any aspects can be implemented and/or supplied and/or used independently. It will be apparent to those skilled in the art that various modifications and improvements may be made without departing from the scope and spirit of the present disclosure. Those skilled in the art would appreciate that the actions of the processes discussed herein may be omitted, modified, combined, and/or rearranged, and any additional actions may be performed without departing from the scope of the disclosure.

Any system features as described herein may also be provided as a method feature and vice versa. As used herein, means plus function features may be expressed alternatively in terms of their corresponding structure. It shall be further appreciated that the systems and/or methods described above may be applied to, or used in accordance with, other systems and/or methods.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

This specification discloses embodiments which include, but are not limited to, the following:
1. A housing for an electrical energy store, the housing comprising:
   a first and second opening each arranged to allow access to an interior of the housing, wherein the first opening is attachable to an arrangement configured to provide a fire extinguishing medium to the housing, and the second opening is arranged to allow the fire extinguishing medium to be collected from the housing; and
   the first opening is arranged to provide a fluid flow path for the fire extinguishing medium to pass over an electrical energy store positioned inside the housing and the second opening is arranged to provide a fluid flow path for the fire extinguishing medium to exit the housing; and
   wherein at least one of the first opening and the second opening comprises a closing arrangement configured to prevent access to the fluid flow path of at least one of the first and second openings until at least one pre-defined condition is met.
2. The housing of item 1, wherein at least one of the first opening and the second opening further comprises a conduit, the conduit being arranged to provide a fluid flow path between the exterior of the body of a vehicle and the interior of the housing, and preferably wherein the conduit is arranged to provide access between the exterior of the body of a vehicle and the interior of the housing through a manifold.
3. The housing of item 1 or item 2, wherein the fire extinguishing medium is recirculated from the second opening back into the first opening through a recirculation arrangement, and preferably wherein the recirculation arrangement is different from the arrangement configured to provide a fire extinguishing medium.
4. The housing of any preceding item, further comprising a flange arranged to provide a channel for guiding the fire extinguishing medium between the interior of the housing and the exterior of the housing.
5. The housing of any preceding item, wherein the first opening is attachable to the arrangement configured to provide the fire extinguishing medium to the housing through a quick-fit connection.
6. The housing of any preceding item, wherein the closing arrangement is biased into a closed position, and preferably wherein the closing arrangement is a solenoid, the solenoid being powered shut.
7. The housing of any preceding item, further comprising a temperature sensor arranged detect the temperature of the electrical energy store, and/or wherein the at least one pre-defined condition is met when the electrical energy store exceeds a temperature of 100 degrees Celsius.
8. A method for providing a fire extinguishing medium to a housing for an electrical energy store having an opening and a closing arrangement arranged over the opening, the method comprising:
   detecting, using a temperature sensor, a temperature within the housing for an electrical energy store,
   determining, using control circuitry, if the temperature within the housing for the electrical energy store exceeds a predefined threshold and, in response to the temperature of the electrical energy store exceeds a pre-defined threshold, moving the closing arrangement from a closed position to an open position, such that the opening in the housing may receive an arrangement for providing a fire extinguishing medium to the housing.
9. The method of item 8, wherein the temperature sensor is configured to detect the temperature of an electrical energy store inside the housing for an electrical energy store.
10. The method of item 8 or item 9, wherein a temperature sensor reading is taken at pre-determined intervals.
11. A vehicle comprising the housing for an electrical energy store of item 1, wherein the vehicle body further comprises an opening corresponding to each of the first and second openings of the housing.
12. The vehicle of item 11, wherein at least one of the first opening and the second opening of the housing further comprises at least one conduit, the or each conduit being arranged to provide a fluid flow path between the exterior of the body of a vehicle and the interior of the housing.
13. The vehicle of item 11 or item 12, wherein the or each conduit is arranged to provide access between the exterior of the body of a vehicle and the interior of the housing through a manifold.
14. The vehicle of any one of items 11 to 13, further comprising flaps arranged to cover openings on the exterior of the body of the vehicle, and preferably wherein the flaps open when at least one pre-defined condition is met, and wherein the pre-defined condition is a temperature of the interior of the housing.
15. The vehicle of any one of items 11 to 14, further comprising a temperature sensing arrangement connected to control circuitry, wherein the temperature sensing arrangement is configured to detect a temperature of the interior of the housing.

What is claimed is:

1. A housing for an electrical energy store, the housing comprising:
a first and second opening each arranged to allow access to an interior of the housing, wherein the first opening is attachable to an arrangement configured to provide a fire extinguishing medium to the housing, and the second opening is arranged to allow the fire extinguishing medium to be collected from the housing; and
the first opening is arranged to provide a fluid flow path for the fire extinguishing medium to pass over an electrical energy store positioned inside the housing and the second opening is arranged to provide a fluid flow path for the fire extinguishing medium to exit the housing; and
wherein at least one of the first opening and the second opening comprises a closing arrangement configured to prevent access to the fluid flow path of at least one of the first and second openings until at least one pre-defined condition is met.

2. The housing of claim 1, wherein at least one of the first opening and the second opening further comprises a conduit, the conduit being arranged to provide a fluid flow path between the exterior of the body of a vehicle and the interior of the housing.

3. The housing of claim 2, wherein the conduit is arranged to provide access between the exterior of the body of a vehicle and the interior of the housing through a manifold.

4. The housing of claim 1, wherein the fire extinguishing medium is recirculated from the second opening back into the first opening through a recirculation arrangement.

5. The housing of claim 4, wherein the recirculation arrangement is different from the arrangement configured to provide a fire extinguishing medium.

6. The housing of claim 1, further comprising a flange arranged to provide a channel for guiding the fire extinguishing medium between the interior of the housing and the exterior of the housing.

7. The housing of claim 1, wherein the first opening is attachable to the arrangement configured to provide the fire extinguishing medium to the housing through a quick-fit connection.

8. The housing of claim 1, wherein the closing arrangement is biased into a closed position.

9. The housing of claim 8, wherein the closing arrangement is a solenoid, the solenoid being powered shut.

10. The housing of claim 1, further comprising a temperature sensor arranged detect the temperature of the electrical energy store.

11. The housing of claim 1, wherein the at least one pre-defined condition is met when the electrical energy store exceeds a temperature of 100 degrees Celsius.

12. A method for providing a fire extinguishing medium to a housing for an electrical energy store having an opening and a closing arrangement arranged over the opening, the method comprising:
detecting, using a temperature sensor, a temperature within the housing for an electrical energy store,
determining, using control circuitry, if the temperature within the housing for the electrical energy store exceeds a predefined threshold and, in response to determining that the temperature of the electrical energy store exceeds a pre-defined threshold, moving the closing arrangement from a closed position to an open position, such that the opening in the housing receives an arrangement for providing a fire extinguishing medium to the housing.

13. The method of claim 12, wherein the temperature sensor is configured to detect the temperature of an electrical energy store inside the housing for an electrical energy store.

14. The method of claim 12, wherein a temperature sensor reading is taken at pre-determined intervals.

15. A vehicle comprising the housing for an electrical energy store of claim 1, wherein the vehicle body further comprises an opening corresponding to each of the first and second openings of the housing.

16. The vehicle of claim 15, wherein at least one of the first opening and the second opening of the housing further comprises at least one conduit, the at least one conduit being arranged to provide a fluid flow path between the exterior of the body of a vehicle and the interior of the housing.

17. The vehicle of claim 15, wherein the at least one conduit is arranged to provide access between the exterior of the body of a vehicle and the interior of the housing through a manifold.

18. The vehicle of claim 15, further comprising flaps arranged to cover openings on the exterior of the body of the vehicle.

19. The vehicle of claim 15, further comprising a temperature sensing arrangement connected to control circuitry, wherein the temperature sensing arrangement is configured to detect a temperature of the interior of the housing.

20. The vehicle of claim 18, wherein the flaps open when at least one pre-defined condition is met, and wherein the pre-defined condition is a temperature of the interior of the housing.
